(19) United States
(12) Patent Application Publication
(10) Pub. No.: US 2011/0151936 A1
(43) Pub. Date: Jun. 23, 2011

(54) INPUT KEY OUTPUT METHOD AND APPARATUS OF PROJECTOR-ENABLED MOBILE TERMINAL

(75) Inventors: Si Hak JANG, Yongin-si (KR); Hee Woon KIM, Suwon-si (KR)

(73) Assignee: SAMSUNG ELECTRONICS CO. LTD., Suwon-si (KR)

(21) Appl. No.: 12/944,983

(22) Filed: Nov. 12, 2010

(30) Foreign Application Priority Data
Dec. 21, 2009 (KR) 10-2009-0127862

(51) Int. Cl. H04B 1/38; G09G 5/00

(52) U.S. Cl. 455/566; 345/156

(57) ABSTRACT

An input key output method and apparatus of a projector-enabled mobile terminal for projecting the key input by the user efficiently are provided. The method of a mobile terminal includes detecting at least one key input, displaying the at least one key on a display of the mobile terminal, and outputting the at least one key to outside of the mobile terminal.

### PRIORITY

This application claims the benefit under 35 U.S.C.§119(a) of a Korean patent application filed on Dec. 21, 2009 in the Korean Intellectual Property Office and assigned Serial No. 10-2009-0127862, the entire disclosure of which is hereby incorporated by reference.

### BACKGROUND OF THE INVENTION

1. Field of the Invention

The present invention relates to a mobile terminal. More particularly, the present invention relates to an input key output method and apparatus of a projector-enabled mobile terminal for efficiently projecting key input.

2. Description of the Related Art

With the rapid increase of use, the mobile phone has become widely used. Also, the mobile phone has evolved to become a multifunctional device supporting various supplementary services including data communication service as well as basic voice communication service.

Recently, a mobile terminal equipped with a projector module has been developed to project an image corresponding to video data (i.e., picture data and text data) stored in its storage on a projection screen or wall.

The projector-enabled mobile terminal is provided with a basic display such as a Liquid Crystal Display (LCD) as well as the projector module. The projector-enabled mobile terminal can output the image by means of the display and the projector module simultaneously. If a user inputs a key, the mobile terminal controls the projector module and the display to output a character corresponding to the key. The output of the characters corresponding to the keys input by the user through the projector module and the display can be important to transfer the user's intended idea to the viewers effectively.

Therefore, a need exists for a method and apparatus for transferring key input on a projector-enabled mobile terminal to viewers.

### SUMMARY OF THE INVENTION

An aspect of the present invention is to address at least the above-mentioned problems and/or disadvantages and to provide at least the advantages described below. Accordingly, an aspect of the present invention is to provide an input key output method and apparatus for a projector-enabled mobile terminal that is capable of transferring the user intention to the viewers of the projection image effectively.

In accordance with an aspect of the present invention, an input key output method of a mobile terminal is provided. The method includes detecting at least one key input, displaying the at least one key on a display of the mobile terminal, and outputting the at least one key external to the mobile terminal.

In accordance with another aspect of the present invention, a mobile terminal is provided. The terminal includes an input unit for receiving at least one key, a display unit for displaying a key input window presenting the key, a projector module for projecting a projection image of the key input window presenting the key, and a control unit for controlling, if the key input is detected, the display unit to display the key in the key input window and controls the projector module to project the projection image of the key input window presenting the key.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following description taken in conjunction with the accompanying drawings, in which:

FIG. 1 is a perspective view of a mobile terminal including a projector module according to an exemplary embodiment of the present invention;

FIG. 2 is a block diagram illustrating a configuration of a mobile terminal according to an exemplary embodiment of the present invention;

FIG. 3 is a flowchart illustrating an input key output method of a mobile terminal according to an exemplary embodiment of the present invention;

FIG. 4 illustrates a process for projecting a character string in a projector-enabled mobile terminal according to an exemplary embodiment of the present invention;

FIG. 5 is a flowchart illustrating an input key output method of a mobile terminal according to an exemplary embodiment of the present invention;

FIG. 6 illustrates screen images of a display unit and projection images of a projector module that are rendered under an external output condition of retrieval of an input character string from a character string list stored in a storage unit according to an exemplary embodiment of the present invention;

FIG. 7 illustrates screen images of a display unit and projection images of a projector module that are rendered under an external output condition of detection of a space following a character according to an exemplary embodiment of the present invention;

FIG. 8 illustrates screen images of a display unit and projection images of a projector module that are rendered under an external output condition of detection of a punctuation mark following a character according to an exemplary embodiment of the present invention;

FIG. 9 illustrates screen images of a display unit and projection images of a projector module that are rendered under an external output condition of detection of a preset time period elapsed after an input of a character according to an exemplary embodiment of the present invention;

FIG. 10 illustrates an input key output method of a mobile terminal according to an exemplary embodiment of the present invention; and

FIG. 11 is a diagram illustrating a screen image and projection image presenting a character string that are rendered by a projector-enabled mobile terminal according to an exemplary embodiment of the present invention.

Throughout the drawings, it should be noted that like reference numbers are used to depict the same or similar elements, features, and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions may be omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

Although exemplary embodiments of the present invention provide a mobile terminal, the present invention is not limited thereto but can be applied to any device having a projector module and a display. The mobile terminal may be any of a portable communication terminal, a Portable Multimedia Player (PMP), a Personal Digital Assistant (PDA), a Smartphone, an MP3 player, and the like. The portable communication terminal may be any of an International Mobile Telecommunication 2000 (IMT-2000) terminal, a Wideband Code Division Multiple Access (WCDMA) terminal, a Global System for Mobile Communication/General Packet Radio Service (GSM/GPRS) terminal, a Universal Mobile Telecommunication Service (UMTS) terminal, and the like.

The exemplary embodiments of the present invention provide a case where a user inputs text by means of an input unit of the mobile terminal

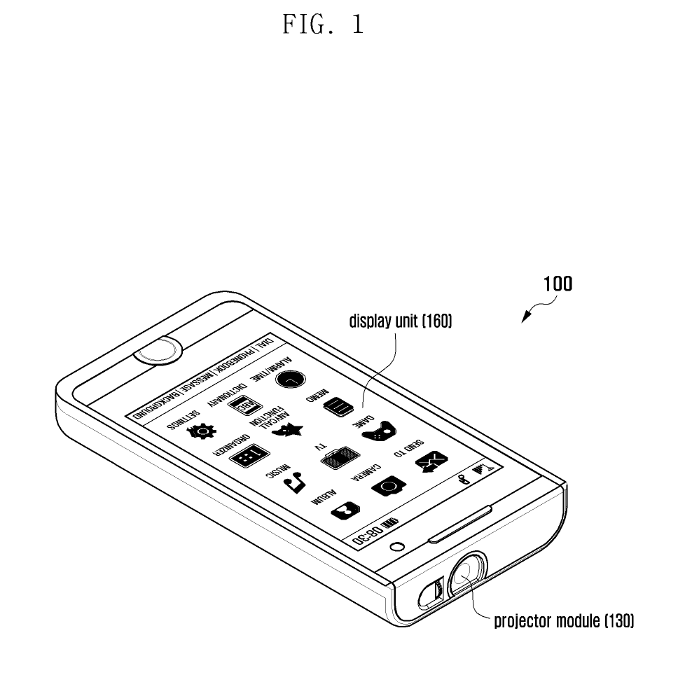

FIG. 1 is a perspective view of a mobile terminal including a projector module according to an exemplary embodiment of the present invention. As illustrated in FIG. 1, the mobile terminal 100 includes a projector module 130 and a display unit 160. FIG. 1 illustrates a touchscreen-enabled mobile terminal 100 including the display unit 160 implemented with a touch panel. The projector module 130 may be arranged at the top side of the mobile terminal 100 to project an image while the user views the same image on the display unit 160. Internal function blocks of the mobile terminal 100 will be described below.

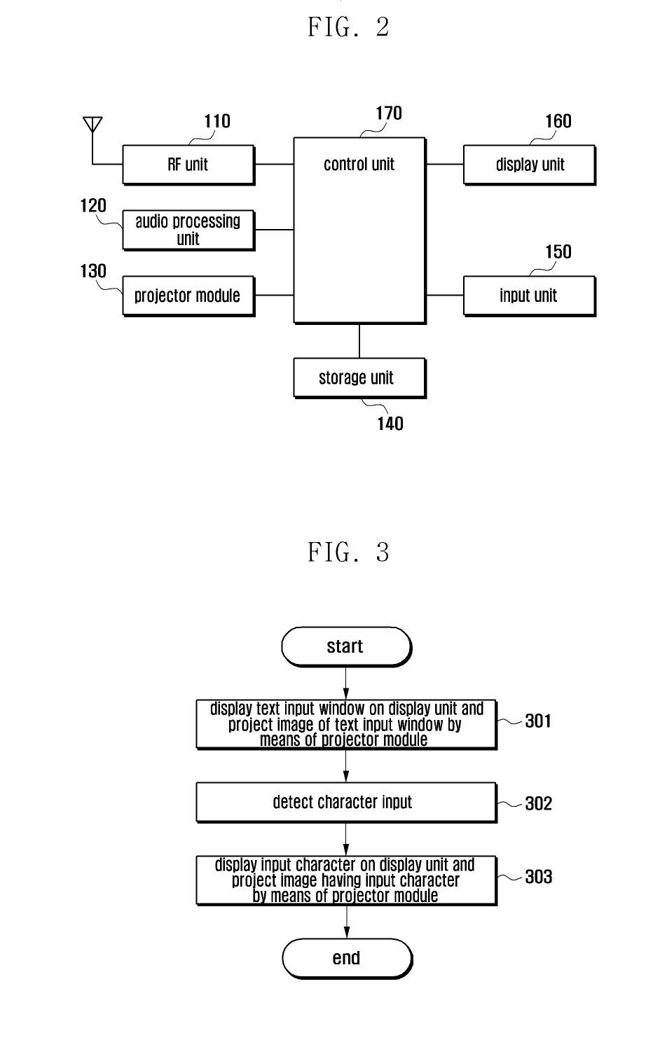

FIG. 2 is a block diagram illustrating a configuration of a mobile terminal according to an exemplary embodiment of the present invention.

Referring to FIG. 2, the mobile terminal 100 includes a Radio Frequency (RF) unit 110, an audio processing unit 120, a projector module 130, a storage unit 140, an input unit 150, a display unit 160, and a control unit 170.

The RF unit 110 is responsible for transmitting and receiving radio signals carrying data. The RF unit 110 may include an RF transmitter for up-converting and amplifying transmission signals and an RF receiver for low-noise-amplifying and down-converting received signals. The RF unit 110 also transfers the received signals to the control unit 170 and transmits data output by the control unit 170 over a radio channel.

The audio processing unit 120 is provided with at least one codec that may include a data codec for processing packet data and an audio codec for processing audio signals including voice. The audio processing unit 120 converts a digital audio signal to output a corresponding analog audio signal through a Speaker (SPK) and converts the analog audio signal input through a Microphone (MIC) to a corresponding digital audio signal by means of the audio codec.

The projector module 130 is a function block responsible for image projection and projects images such as text, a picture, a photo, and a motion picture on an external screen. In an exemplary implementation, the projector module 130 may include a projection lamp (not illustrated) and a focus controller (not illustrated). The projection lamp emits light, and the focus controller controls the focus of the image projected on the external screen. The focus controller may adjust the focus of the projection image under the control of the control unit 170. In a case where the mobile terminal 100 is provided with a separate control device (e.g., a wheel key), it is possible to adjust the focus of the projection image in response to user manipulation.

The storage unit 140 stores application programs and data related to operations of the mobile terminal 100 and may be divided into a program region and a data region. The storage unit 140 may be implemented with a volatile storage medium or a nonvolatile storage medium or combination thereof. The volatile medium includes a semiconductor memory such as a Random Access Memory (RAM), a Dynamic RAM (DRAM), a Static RAM (SRAM), and the like, and the nonvolatile memory includes a hard disk. According to an exemplary embodiment of the present invention, the storage unit 140 may store an external output condition of the projector module 130. In an exemplary case where the external output condition is a sequence of characters input by the user and is identical with a previously stored character or sequence of characters, the storage unit 140 stores a list of the reference characters or character sequences. The storage unit 140 also may store settings of an external output mode of the projector module 130. In an exemplary implementation, there are two external output modes that include a conditional external output mode and a non-conditional external output mode. In the conditional external output mode, the projector module 130 outputs the input character or character sequence, only when the character or character sequence input by the user fulfills the external output conditions. In the non conditional external output mode, the projector module 130 outputs the input character or character sequence input by the user without verifying conditions.

The input unit 150 receives the signal corresponding to the key input by the user and outputs the key signal to the control unit 170. The input unit 150 may be implemented with at least one of a 3×4 or QWERTY keypad having a plurality of alphabetic and numeric keys, a touchpad, a touchscreen, and the like. The input unit 150 generates input signals for executing functions, such as a call placing function, a video and music playback function, an image display function, a broadcast playback function, a camera function, an audio recording function, a calculator function, a schedule management function, and the like, and transferring the input signals to the control unit 170. In an exemplary implementation, the mobile terminal 100 may be a touchscreen-enabled mobile terminal having a touch panel working as the input unit 150. In a case where the input unit 150 is implemented with a touch panel, the mobile terminal 100 may further include a button key, a jog key, a wheel key, and the like. The input unit 150 may further include a focus adjustment key for adjusting the focus of the image projected on the screen. In an exemplary implementation, the input unit 150 may be implemented as a separate external device. For example, in a case where the mobile terminal 100 includes a short range wireless communication module, such as at least one of a Bluetooth module, Infrared module, a ZigBee module, an Ultra-Wide Band (UWB) module, a WiFi module, and the like, and establishes a connection with an external device by means of the short range wireless communication module, the input keys of the external device may be configured to be a part of the input unit 150. In a case where the mobile terminal 100 includes a plurality of projector modules of which at least one outputs a virtual keyboard externally, the output virtual keyboard may be used as a part of the input unit 150.

The display unit 160 may be implemented with an LCD which displays menus of the mobile terminal, input data, function settings, and other information to the user. For example, the display unit 160 displays a booting progress screen, an idle mode screen, a call progress screen, and other application execution screens. In an exemplary implementation, the display unit 160 displays the character or character sequence input by the user. In a case of the touchscreen-enabled mobile terminal, the display unit 150 may work in combination with the input unit 150. The display unit may present alphabetic character keys and provide a character input window region and a character input key region. In an exemplary implementation, the display unit 160 may display the character input window in the form of multiple pages. In this case, the display unit 160 may display the character input window with a scroll bar. In the case of the touchscreen-enable mobile terminal, the user may navigate the pages by manipulating the scroll bar displayed on the display unit 160.

The control unit 170 is responsible for controlling operations of the internal function blocks of the mobile terminal 100. The control unit 170 controls the display unit 160 to display the character input window and controls the projector module 130 to project the character input window image. At this time, the control unit 170 controls the display unit 160 to display the character input window along with the character input keys while the projector module 130 projects the image having only the character input window.

The control unit 170 may recognize the character input by means of the input unit 150. If a character is recognized, the control unit 170 controls the display unit 160 to display the input character and controls the projector module 130 to output the input character as the projection image. The control unit 170 may configure the mobile terminal with one of a conditional external output mode and non-conditional external output mode. In the conditional external output mode, the projector module 130 projects the image presenting the input character only when the input character or character string and the current input status fulfill specific conditions. In the non-conditional external output mode, the projector module 130 projects the image having the character or character string input by the user without checking conditions.

In the non-conditional external output mode, if a character input by means of the input unit 150 is recognized, the control unit 170 controls the display unit 160 to display the input character in real time and controls the projector module 130 to project the image having the input character in real time.

In the conditional external output mode, if a character input by means of the input unit 150 is recognized, the control unit 170 controls the display unit 160 to display the input character in real time and determines whether the input character and the current input status fulfills the preset external output conditions. In an exemplary implementation, the external output condition is the condition required to be fulfilled for outputting the input character by means of the projector module 130. The external output condition may detect a character string retrieving the input character string from the character string list stored in the storage unit 140. The external output condition may also detect the input of space following the character string of at least one character. In an exemplary implementation, the external output condition may detect a punctuation mark following the character string of at least one character. Here, the punctuation mark may be a mark added to clarify the meaning of the text and may include a period (.), a question mark (?), an exclamation mark (!), a comma (,), a dot ( ) a semicolon (;), a colon (:), a slash (/), a double quotation mark (“ ”), and a single quotation mark (‘ ’). In an exemplary implementation, the external output condition may detect a preset time period elapsed after the input of a character.

If it is determined that the input character string (or text) or the current input status fulfills the external output condition, the control unit 170 controls the projector module 130 to project the image having the input character string. At this time, the character string (i.e., text) may be presented differently from that displayed on the display unit 160 in number of lines. Also, a number of characters of each line of the text in the projection image may differ from that in the image displayed on the display unit 160. The control unit 170 may control such that the text is displayed on the display unit 160 in the form of multiple pages while the image having the text is projected by means of the projector module 130 in the form of a single page. In an exemplary implementation, the control unit 170 may control the display unit 160 and the projector module 130 to display the input character string with a character animation effect. The character animation effect may be expressed with change in size, brightness, and color of the characters, addition of specific images, and dynamic shape conversion of the characters. If a character animation effect key is input through the input unit 150, the control unit 170 controls the display unit 160 and the projector module 130 to add the character animation effect to the input character string.

The input key output method of the above structured mobile terminal 100 is described below.

FIG. 3 is a flowchart illustrating an input key output method of a mobile terminal according to an exemplary embodiment of the present invention.

Referring to FIG. 3, the control unit 170 controls the display unit 160 to display a text input window and controls the projector module 130 to project an image having the text input window in step 301. In an exemplary implementation, the control unit 170 controls the display unit 160 to display the text input window and a set of character keys and controls the projector module 130 to project the image having only the text input window. The control unit 170 may also control such that the text input window is presented at different aspect ratios by the display unit 160 and the projector module 130. For example, the control unit 170 may control to display the text input window at the aspect ratio of 4:3 on the display unit 160 and project the image having the text input window at the aspect ratio of 6:5.

The control unit 170 detects a character string input through the input unit 150 by the user in step 302. The user may input the character string with the keys of the input unit 150 represented by a touch panel or a keypad. If the key input is detected, the input unit 150 generates the input signal corresponding to the key and transfers the input signal to the control unit 170 such that the control unit 170 recognizes the character string input by the user.

Once the input character string is recognized, the control unit 170 controls the display unit 160 to display the character string in real time and controls the projector module 130 to project the image having the character string externally in real time in step 303.

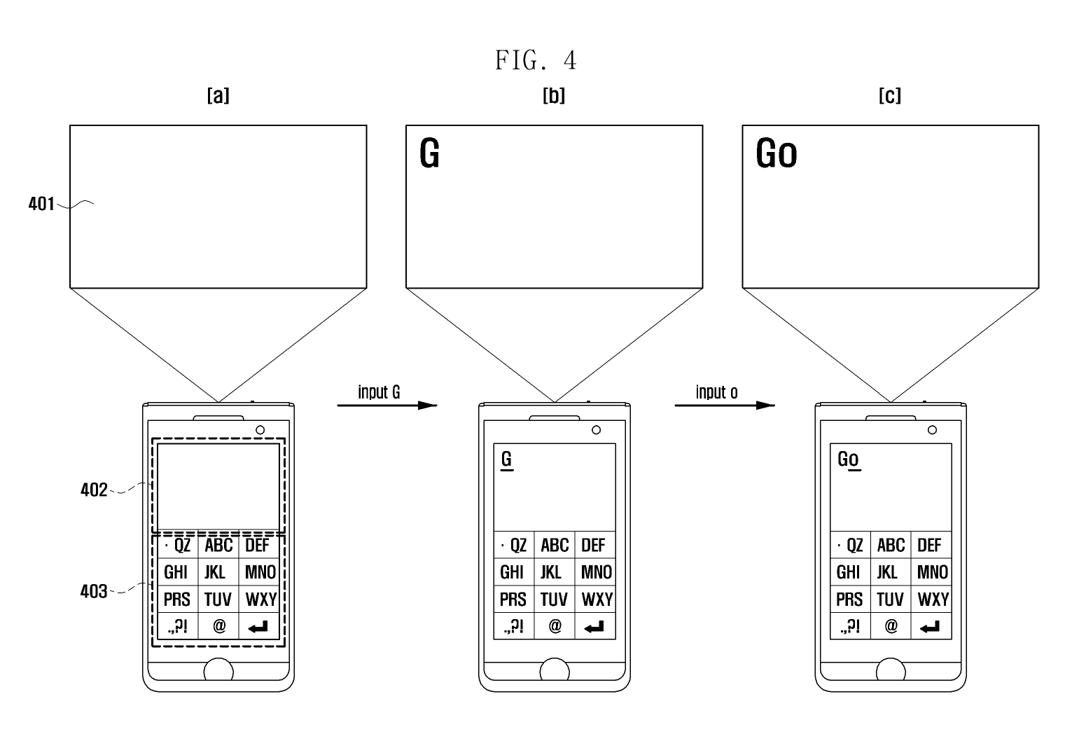

FIG. 4 is a diagram illustrating a process for projecting a character string in a projector-enabled mobile terminal according to an exemplary embodiment of the present invention.

Referring to FIG. 4, part [a] illustrates a screen image having an empty text input window 402 which is displayed by the display unit 160 and a projection image 401 of the text input window 402 which is projected by the projector module 130. In FIG. 4, the mobile terminal 100 is depicted as having a full touchscreen which displays a virtual keypad 403 having a set of character input keys along with the text input window.

Part [b] of FIG. 4 illustrates the display unit 160 displaying the text input window 402 having a character ‘G’ input by the user and the projection image 401 of the text input window 402 which is projected by the projector module 130. As illustrated in part [b] of FIG. 4, the mobile terminal 100 displays the text input window having the input character ‘G’ on the display unit 160 and projects the image of the same text input window (e.g., on a screen) by means of the projector module 130.

Part [c] of FIG. 4 illustrates the display unit 160 displaying the text input window 402 having a string of characters ‘G’ and ‘o’ input in series and the projection image 401 of the same text input window 402 which is projected by the projector module 130. That is, the mobile terminal 100 displays the text input window having the text ‘Go’ and projects the image of the same text input window 402 by means of the projector module 130.

In an exemplary embodiment of the present invention, the mobile terminal 100 controls such that, whenever a character is input by the user, the display unit 160 and the projector module 130 renders the input character on the text input window image displayed on the display screen and projected to the outside in real time. The display unit 160 reflecting the input character to its display screen image in real time while the projector module 130 reflecting the input character to its projection image only when a preset condition is fulfilled is described below.

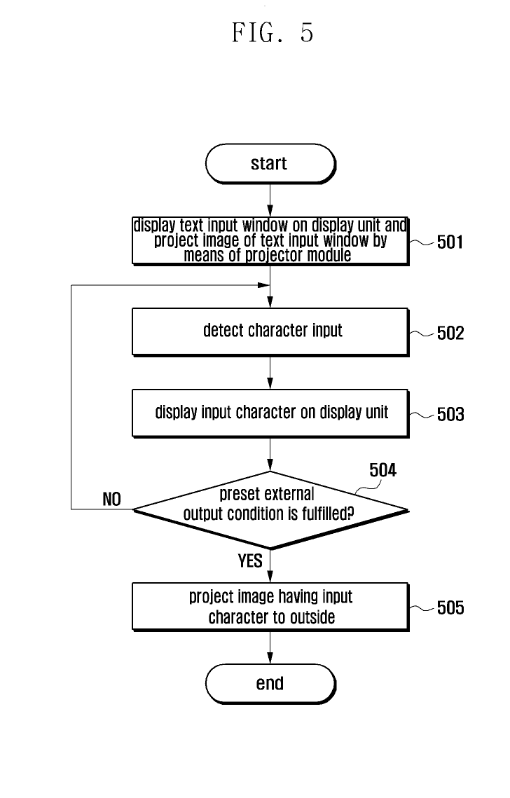

FIG. 5 is a flowchart illustrating an input key output method of a mobile terminal according to an exemplary embodiment of the present invention.

Steps 501 and 502 of FIG. 5 are identical with steps 301 and 302 of FIG. 3. That is, the control unit 170 controls the display unit 160 to display the text input window and the projector module 130 to project the projection image of the text window and recognizes the character input by means of the input unit 150.

Once the character input through the input unit 150 is recognized, the control unit 170 controls the display unit 160 to display the input character in real time in step 503. The control unit 170 determines whether the external output condition is fulfilled in step 504. Here, the display unit 160 displays the input character in real time as feedback information with which the user may determine whether the correct character is input. The external output condition is stored in the storage unit 140 in advance, and the control unit 170 references the external output condition to determine whether the input character and/or the current input status fulfils the external output condition. In an exemplary implementation, the external output condition is the condition to be fulfilled for the projector module 130 to project the character input by the user to the outside. The external output condition may be detection of a character string retrieving the input character string from the character string list stored in the storage unit 140. The external output condition may also detect the input of space following the character string of at least one character. In an exemplary implementation, the external output condition may detect a punctuation mark following the character string of at least one character. The external output condition may detect a preset time period elapsed after the input of a character.

If the external output condition is fulfilled in step 504, the control unit 170 controls the projector module 130 to project the input character string externally in step 505.

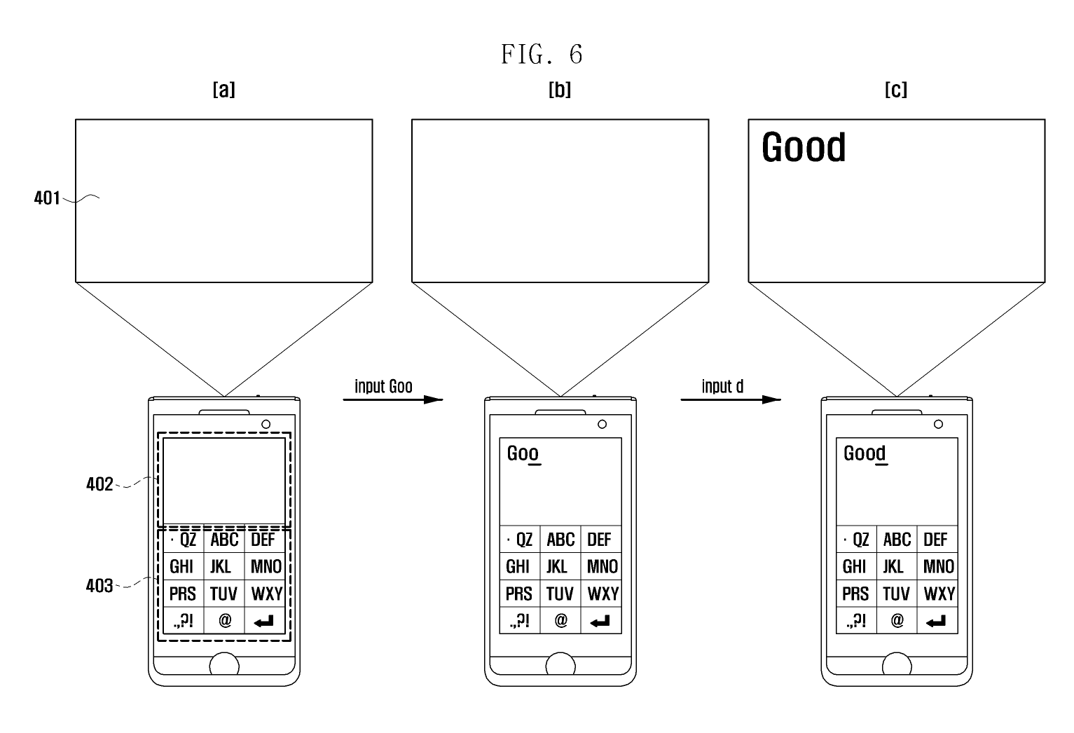

FIGS. 6 to 9 are diagrams illustrating processes for projecting a character string under respective external output conditions in a projector-enable mobile terminal according to an exemplary embodiment of the present invention.

FIG. 6 illustrates screen images of a display unit and projection images of a projector module rendered under an external output condition of retrieval of an input character string from the character string list stored in a storage unit according to an exemplary embodiment of the present invention.

In FIG. 6, it is assumed that the character string list contains the character string ‘Good’.

Referring to FIG. 6, part [a] illustrates a screen image having an empty text input window 402 which is displayed by the display unit 160 and a projection image 401 of the text input window 402 which is projected by the projector module 130. In part [b] of FIG. 6, the display unit 160 displays a character string ‘Goo’ in the text input window 402 in response to the user's sequential input while the projector module 130 projects the projection image 401 of the empty text input window. Here, the input of the character string ‘Goo’ is not reflected to the projection image 401 because the character string ‘Goo’ does not fulfill the external output condition, i.e., the character string ‘Goo’ is not contained in the character string list.

In part [c] of FIG. 6, the display unit 160 displays the character ‘d’ right after the previously input characters ‘Goo’ in sequential order such that the character string ‘Good’ is presented in the text input window 402. At this time, the projector module 130 projects the projection image 401 of the text input window 402 presenting the text string ‘Good’ because the character string ‘Good’ fulfills the external output condition, i.e., the character string ‘Good’ is contained in the character string list.

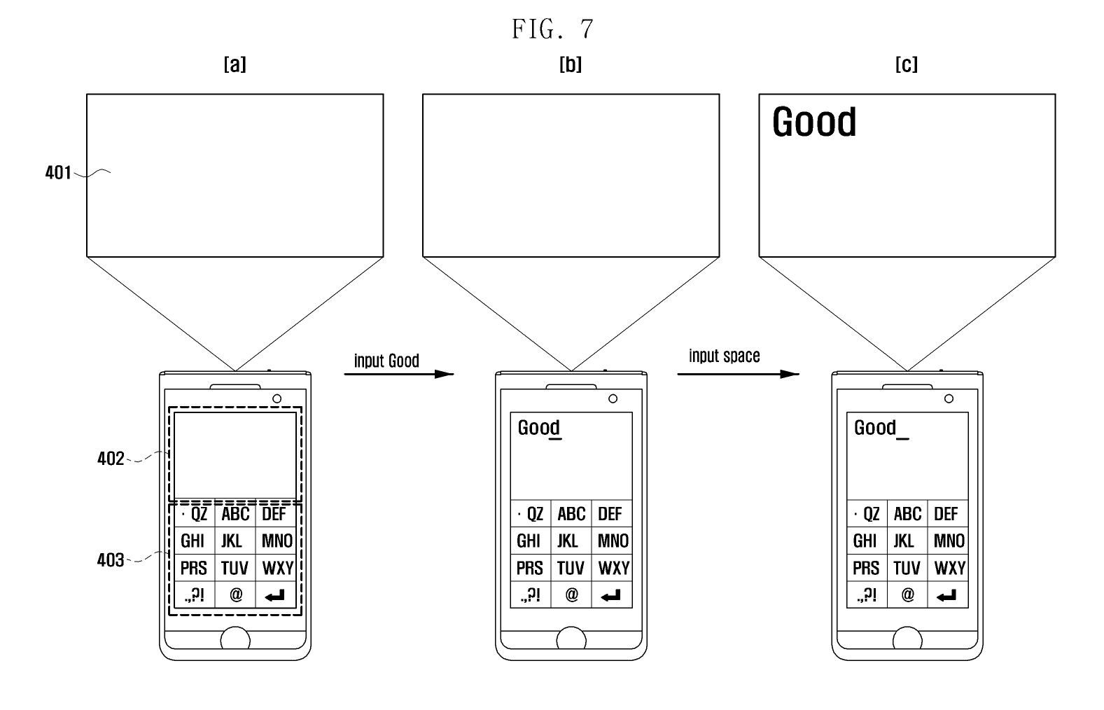

FIG. 7 illustrates screen images of a display unit and projection images of a projector module that are rendered under an external output condition of detection of space following a character according to an exemplary embodiment of the present invention.

Referring to FIG. 7, part [a] illustrates a screen image having an empty text input window 402 which is displayed by the display unit 160 and a projection image 401 of the text input window 402 which is projected by the projector module 130. As illustrated in part [b] of FIG. 7, the display unit 160 displays the character string ‘Good’ in response to the user's input of the individual characters in series while the projector module 130 projects the projection image of the empty text input window. Here, the complete character string ‘Good’ is not presented in the text input window of the projection image since the external output condition is not fulfilled, i.e., no space is detected yet.

As illustrated in part [c] of FIG. 7, the projector module 130 projects the projection image of the text input window presenting the character string ‘Good’ upon detecting the space input by the user while the display unit 160 displays the screen image having the character string ‘Good’ in the text input window. If the space is input, the cursor shifts to indicate the input of the space, and the mobile terminal 100 controls the projector module 130 to project the image of the text input window presenting the character string ‘Good’.

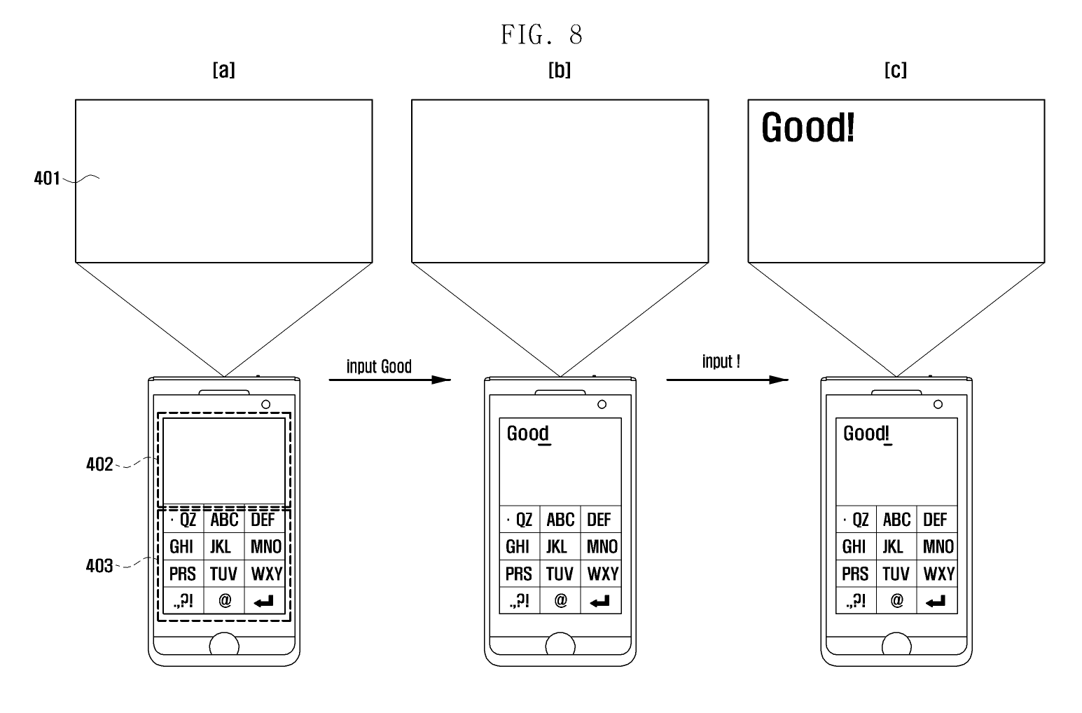

FIG. 8 illustrates screen images of a display unit and projection images of a projector module that are rendered under an external output condition of detection of a punctuation mark following a character according to an exemplary embodiment of the present invention.

Referring to FIG. 8, part [a] illustrates a screen image having an empty text input window 402 which is displayed by the display unit 160 and a projection image 401 of the text input window 402 which is projected by the projector module 130. As illustrated in part [b] of FIG. 8, the display unit 160 displays the character string ‘Good’ in response to the user's input of the individual characters in series while the projector module 130 projects the projection image of the empty text input window. Here, the complete character string ‘Good’ is not presented in the text input window of the projection image since the external output condition is not fulfilled, i.e., no punctuation mark is detected yet.

As illustrated in part [c] of FIG. 8, the projector module 130 projects the projection image of the text input window presenting the character string ‘Good’ upon detecting the quotation mark, i.e., ‘!’, input by the user while the display unit 160 displays the screen image having the character string ‘Good’ in the text input window.

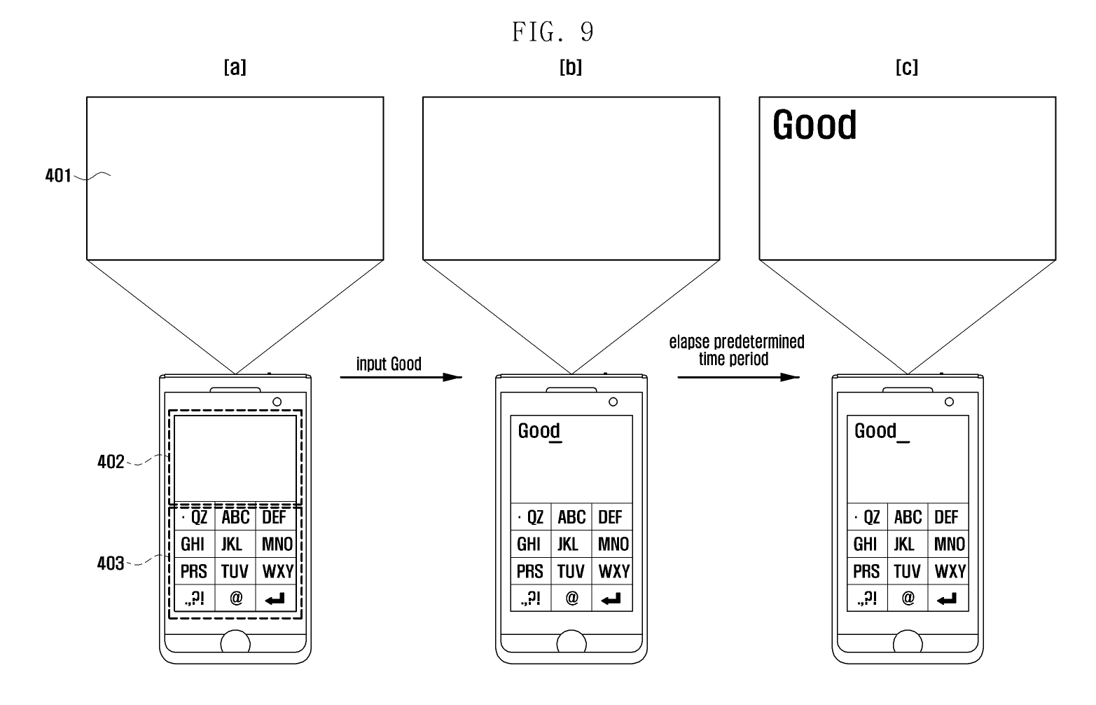

FIG. 9 illustrates screen images of a display unit and projection images of a projector module that are rendered under an external output condition of detection of a preset time period elapsed after input of a character according to an exemplary embodiment of the present invention.

In the case of FIG. 9, it is assumed that the time period is preset.

Referring to FIG. 9, part [a] illustrates a screen image having an empty text input window 402 which is displayed by the display unit 160 and a projection image 401 of the text input window 402 which is projected by the projector module 130. As illustrated in part [b] of FIG. 9, the display unit 160 displays the character string ‘Good’ in response to the user's input of the individual characters in series while the projector module 130 projects the projection image of the empty text input window. Here, the complete character string ‘Good’ is not presented in the text input window of the projection image since the external output condition is not fulfilled, i.e. the preset time period is not elapsed yet.

As illustrated in part [c] of FIG. 9, the projector module 130 projects the projection image of the text input window presenting the character string ‘Good’ upon the elapse of the preset time after the input of the last character while the display unit 160 displays the screen image having the character string ‘Good’ in the text input window.

If the preset time has elapsed after the input of the last character, the mobile terminal 100 may shift the cursor to indicate the next input position.

In an exemplary embodiment of the present invention, the mobile terminal 100 controls the display unit 160 to display each character, whenever the characters are input by the user, in real time and controls the projector module 130 to project the projection image having a character string only when the external output condition is fulfilled. In an exemplary embodiment of the present invention, the external output condition may be the detection of one of a space, a punctuation mark, a retrieval of the input string from the character string list, a lapse of the preset time period after the input of the last character. In an exemplary implementation, the mobile terminal 100 may control the projector module 130 to update the projection image in a word unit to prevent unnecessarily taken-actions from being displayed during the presentation, resulting in improvement of viewers' concentration.

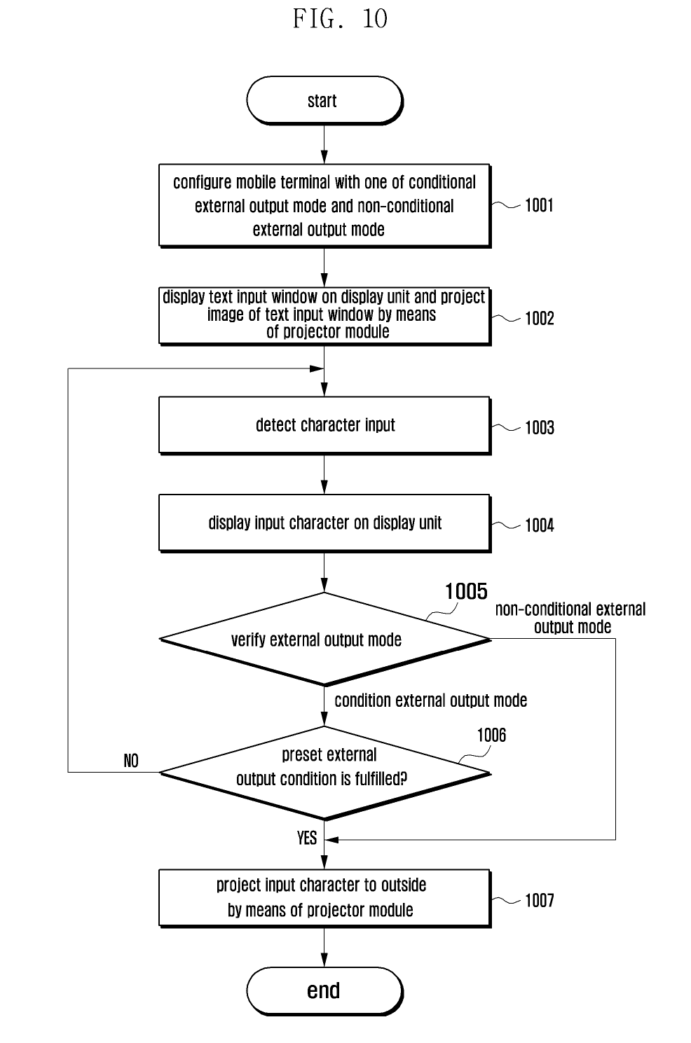

The exemplary embodiments of the present invention may be implemented with characteristics as described below with reference to FIG. 10.

FIG. 10 is a flowchart illustrating an input key output method of a mobile terminal according to an exemplary embodiment of the present invention.

Referring to FIG. 10, the control unit 170 sets the mobile terminal with one of a conditional external output mode and a non-conditional external output mode and saves the set external output mode in the storage unit 140 in step 1001. In the conditional external output mode, the projector module 130 updates the projection image having the character string input by the user only when the preset condition is fulfilled. In the non-conditional external output mode, the projector module 130 updates the projection image whenever a character is input. The mobile terminal 100 provides an external output mode configuration menu, and the control unit 170 controls the display unit 160 to display the external output mode configuration menu screen. If the user selects one of the conditional external output mode and the non-conditional external output mode, the control unit 170 configures the mobile terminal with the selected external output mode and saves the corresponding settings in the storage unit 140.

Steps 1002 to 1004 of FIG. 10 are identical with steps 501 to 503 of FIG. 5. That is, the control unit 170 controls the display unit 160 to display the screen image having the text input window and the projector module 130 to projects a projection image of the text input window, detects the character input by means of the input unit 150, and presents the input character in the screen image displayed by the display unit 160.

The control unit 170 verifies the settings of the external output mode to determine whether the current external output mode is the conditional external output mode or the non-conditional external output mode in step 1005.

If the current external output mode is the conditional external output mode, the control unit 170 determines whether the present external output condition is fulfilled by the input character or the current input status in step 1006. For example, the control unit 170 determines whether the input character string is contained in the character string list, a space is input after a character, a punctuation mark is input after a character, or a preset time period elapses after a character. If the external output condition is fulfilled, the control unit 170 controls the projector module 130 to project the projection image presenting the character string. Otherwise, if the external output condition is not fulfilled, the control unit 170 returns to step 1003 to detect the next input.

If the current external output mode is the non-conditional external output mode, the control unit 170 controls the projector module 130 to project the projection image presenting the currently input character in real time in step 1007.

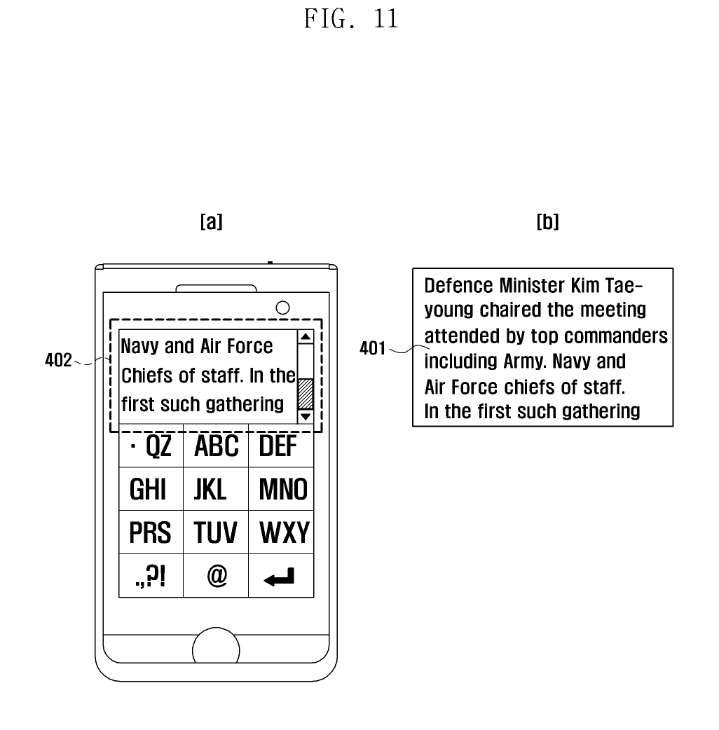

In an exemplary implementation, the control unit 170 may control such that the character strings presented in the screen image of the display unit 160 and the projection image of the projector module 130 differ from each other in number of lines. The control unit 170 may also control such that character strings presented in the screen image of the display unit 160 and the projection image of the projector module 130 differ from each other in number of characters on the corresponding lines. The control unit 170 may also control the display unit 160 to display the text input window presenting the character string in the form of multiple pages while the projector module 130 displays the text input window on a single projection image. The displaying of the text input window presenting the character string in the form of multiple pages while the projector module 130 displays the text input window on a single projection image is described in more detail with reference to FIG. 11.

FIG. 11 is a diagram illustrating an exemplary screen image and projection image presenting a character string that are rendered by a projector-enabled mobile terminal according to an exemplary embodiment of the present invention.

Referring to FIG. 11, part [a] illustrates the screen image having the text input window presenting the input character string which is displayed by the display unit 160, and part [b] of FIG. 11 illustrates the projection image of the text input window which is projected by the projector module 130.

In part [a] of FIG. 11, the character string is presented in the form of multiline text in the text input window 402 in which three lines are exposed with a scroll bar. In part [b] of FIG. 11, the character string is presented in the form of multiline text on the projection image 401 in which all the lines of the text are exposed. That is, the mobile terminal 100 may render the character string differently for the screen image and the projection image in maximum number of lines.

The text input window 402 of the screen image is provided with a scroll bar at the right side such that the user may scroll the text across the text input window 402. However, the text input window of the projection image 401 does not have a scroll bar as illustrated in part [b] of FIG. 11. That is, the mobile terminal 100 may provide the text in the form of multiple pages to be presented in the text input window 402 of the screen image and in the form of a single page to be presented on the projection image.

The mobile terminal 100 may be configured to output the text (i.e., character string) on the screen image of the display unit 160 and the projection image of the projector module 130 in the same format or different formats in which the characters are arranged differently. The word ‘Navy’ is the first word on the first line of the text in text window 402 of part [a] of FIG. 11, but it is the third word on the fourth line of the text presented on the projection image 401. That is, the mobile terminal 100 may form the same text in different formats having different number of characters on a single line and, as a consequence, the same word may be placed at different positions.

In an exemplary implementation, the control unit 170 may control the display unit 160 and the projector module 130 to display the characters with animation effects. The character animation effect may be expressed with change in size, brightness, and color of the characters, addition of specific images, and dynamic shape conversion of the characters.

If a character animation effect key is input through the input unit 150, the control unit 170 controls the display unit 160 and the projector module 130 to add the character animation effect to the input character string.

The above-described input key output method of the present invention may be implemented in the form of computer-executable program commands and stored in a computer-readable storage medium. The computer readable storage medium may store the program commands, data files, and data structures in individual or combined forms. The program commands recorded in the storage medium can be designed and implemented for the exemplary embodiments of the present invention or used by those skilled in the computer software field.

The computer-readable storage medium includes magnetic media such as a floppy disk and a magnetic tape, optical media including a Compact Disc (CD) Read-Only Memory (ROM) and a Digital Video Disc (DVD) ROM, a magneto-optical media such as a floptical disk, and the hardware device designed for storing and executing program commands such as a ROM, a Random Access Memory (RAM), and a flash memory. The programs commands include the language code executable by computers using an interpreter as well as the machine language codes created by a compiler. The aforementioned hardware device may be implemented with one or more software modules for executing operations of the present invention.

As described above, the input key output method and apparatus for a projector-enabled mobile terminal is capable of transferring a user's intention to viewers of a presentation effectively.

While the invention has been described with reference to certain exemplary embodiments thereof, it will be understood by those skilled in the art that various changes in form and details may be made therein without departing from the spirit and scope of the invention as defined in the appended claims and their equivalents.

What is claimed is:

1. An input key output method of a mobile terminal, the method comprising:
detecting at least one key input;
displaying the at least one key on a display of the mobile terminal; and
outputting the at least one key external to the mobile terminal.

2. The method of claim 1, further comprising:
displaying a key input window on the display of the mobile terminal; and
outputting the key input window external to the mobile terminal.

3. The method of claim 2, wherein the outputting of the key input window comprises:
displaying a screen image having the key input window and a key region on the display; and
outputting the key input window except for the key region.

4. The method of claim 1, wherein the outputting of the at least one key comprises:
displaying at least one key on the display of the mobile terminal;
determining whether a preset external output condition is fulfilled by the input of the at least one key; and
outputting, if the external output condition is fulfilled, the at least one key external to the mobile terminal.

5. The method of claim 4, wherein the determining of whether the preset external output condition is fulfilled comprises determining whether the at least one key is contained in a character string list.

6. The method of claim 4, wherein the determining of whether the preset external output condition is fulfilled comprises determining whether a last key of the at least one key is a space key.

7. The method of claim 4, wherein the determining of whether the preset external output condition is fulfilled comprises determining whether a last input key of the at least one key is a punctuation mark key.

8. The method of claim 4, wherein the determining of whether the preset external output condition is fulfilled comprises determining whether a preset time period elapses after inputting the at least one key.

9. The method of claim 1, wherein the outputting of the at least one key comprises composing text with the at least one key which is arranged on a number of lines, which differs from a number of lines of the text composed with the at least one key displayed on the display of the mobile terminal, and outputting the text external to the mobile terminal.

10. The method of claim 1, wherein the outputting of the at least one key comprises composing text with the at least one key which is arranged on a number of lines, which includes a number of keys that differs from a number of keys of each line of the text displayed on the display of the terminal, and outputting the text external to the mobile terminal.

11. The method of claim 1, wherein the outputting of the at least one key comprises:
outputting a page presenting text composed of the at least one key external to the mobile terminal; and
displaying a set of pages presenting the text composed of the at least one key on the display of the mobile terminal.

12. The method of claim 1, further comprising:
configuring the mobile terminal with one of a conditional external output mode and a non-conditional external output mode.

13. The method of claim 12, wherein the outputting of the at least one key comprises:
displaying, if the mobile terminal is configured with the conditional external output mode, the at least one key input on the display of the mobile terminal;
determining whether a preset external output condition is fulfilled by the input of the at least one key; and
outputting, if the preset external output condition is fulfilled, the at least one key external to the mobile terminal.

14. The method of claim 12, wherein the outputting of the at least one key comprises:
displaying, if the mobile terminal is configured with the non-conditional external output mode, the at least one key input on the display of the mobile terminal in real time; and
outputting, the at least one key external to the mobile terminal in real time.

15. A mobile terminal comprising:
an input unit for receiving at least one key;
a display unit for displaying a key input window presenting the key;
a projector module for projecting a projection image of the key input window presenting the key; and
a control unit for controlling, if the key input is detected, the display unit to display the key in the key input window and controls the projector module to project the projection image of the key input window presenting the key.

16. The mobile terminal of claim 15, wherein the control unit controls, if the key input is detected, the display unit to display the input key in real time, determines whether a preset external output condition is fulfilled by the key, and controls, if the preset external output condition is fulfilled, the projector module to project the projection image presenting the input key.

17. The mobile terminal of claim 16, wherein the fulfilled preset external output condition comprises at least one of a last input key is a space key, a last input key is a punctuation mark key, at least one key is contained in a character string list, and a preset time period elapses after the last input key.

18. The mobile terminal of claim 15, wherein the control unit determines at least one of whether the at least one key is contained in a previously stored character string list, whether a last key of the at least one key is a space key, whether a last input key of the at least one key is a punctuation mark key, and whether a preset time period elapses after inputting the at least one key.

19. The mobile terminal of claim 15, wherein the key displayed in the key input window is arranged on a number of lines which differs from a number of lines of the key presented in the projection image of the key input window.
